(19) United States
(12) Patent Application Publication
(10) Pub. No.: US 2004/0179454 A1
(43) Pub. Date: Sep. 16, 2004

(54) Method of recording data on recordable disk, method of protecting sync included in recorded data, information storage medium, and apparatus for reproducing data recorded on recordable disk

(75) Inventors: Jae-seong Shim, Seoul (KR); Jin-han Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/798,268

(22) Filed: Mar. 12, 2004

(30) Foreign Application Priority Data
Mar. 13, 2003 (KR) 2003-15879
Apr. 23, 2003 (KR) 2003-25714

(51) Int. Cl. G11B 7/00

(52) U.S. Cl. 369/59.24

(57) ABSTRACT

A method of recording data on a recordable disk so that data is stably reproducible, a method of protecting syncs included in the recorded data, an information storage medium, and an apparatus for reproducing the data recorded on the recordable disk. In the information storage medium, data is recorded in a certain recording unit. The recording unit includes a body and a head. The body includes user data and a first recognizer, and the head is attached in front of the body to protect the body and includes a second recognizer to protect the first recognizer. The second recognizer comprises more patterns than a number of maximum length patterns used to form the first recognizer so that the second recognizer is distinguished from the first recognizer. Thus, even if the data is recorded on the recordable disk at any time, data is properly reproducible.

### CROSS-REFERENCE TO RELATED APPLICATIONS

This application claims the benefit of Korean Patent Application Nos. 2003-15879, filed on Mar. 13, 2003, and 2003-25714, filed on Apr. 23, 2003, in the Korean Intellectual Property Office, the disclosures of which are incorporated herein by reference.

### BACKGROUND OF THE INVENTION

1. Field of the Invention

The present invention relates to a method of recording data in an information storage medium, and more particularly, to a method of recording data on a recordable disk, a method of protecting the syncs included in the recorded data, an information storage medium and an apparatus for reproducing data recorded on the recordable disk.

2. Description of the Related Art

Conventional read-only disks, such as conventional DVD-ROMs, record data only in an uninterrupted time frame. Once recording starts, data is consecutively recorded until the recording is completed. However, rewritable disks such as DVD-RWs may record data at any time, for example, when a user demands.

FIG. 1 shows an operation in which data is recorded on a conventional DVD-RW. Referring to FIG. 1, rewritable disks such as the conventional DVD-RW use an error correction code (ECC) block including 32 KB data as a basic unit in which data is recorded. Data is recorded on rewritable disks in units of ECC blocks. To record additional data, data linking occurs so that recording starts in between fifteenth and seventeenth bytes of a first sync frame of a first physical sector in the ECC block. The data linking does not cause a data redundancy, so an efficiency of a data format may be increased. However, if the data linking does not occur at an exact end position of a recording, all data overlapped by a second sync frame among data of the first sync frame is destroyed and, thus, is not properly reproducible. Furthermore, if the data linking does not start within a predetermined range, (i.e., if the data linking does not start in between a 15^{th} byte and a 17^{th} byte of the first sync frame of a DVD-RW), a possibility exists that a sync of the second sync frame may not be detected. A sync detection is very important to accomplish a proper reproduction of data. Thus, if the sync of the second sync frame is not properly detected, the data of the second sync frame cannot be properly reproduced.

FIGS. 2 through 4 illustrate three different cases in which new data is recorded according to a conventional data recording method based on the data linking. FIG. 2 illustrates a case in which new recording starts exactly at a position where a previous recording ends. In this case, the data reproduction is achievable without errors.

FIG. 3 illustrates a case where an end position of the previous recording is not exactly identical with a start position of a new recording. In this case, the data in a first sync frame SYNC1 is damaged and, thus, cannot be properly reproduced.

FIG. 4 illustrates a case where the new recording occurs while violating a linking rule in a more serious manner than the case illustrated in FIG. 3, that is, the case where a difference between an end position of the previous recording and a start position of the new recording is greater than a protection window protecting a frame of a second sync SYNC2. In this case, the second sync SYNC2 is generated outside of the protection window and is, thus, not detected. The second sync SYNC2 may be inserted into a wrong location in an ECC block, and data within the frame of the second sync SYNC2 may be entirely destroyed.

In the cases illustrated in FIGS. 3 and 4, damaged data may be restored to original data through error correction. However, when these cases occur, a number of generated errors increases, thereby degrading a capability of error correction.

### SUMMARY OF THE INVENTION

The present invention provides a method of recording data so that the recorded data is stably reproduced without damage, a method of protecting the syncs included in the recorded data, an information storage medium which records the data thereon, and an apparatus for reproducing the data recorded on the information storage medium.

The present invention also provides a method of recording data so that the data is properly reproduced even when the data is recorded on a recordable disk at any time, a method of protecting the syncs included in the recorded data, an information storage medium which records the data thereon, and an apparatus for reproducing the data recorded on the information storage medium.

Additional aspects and/or advantages of the invention will be set forth in part in the description which follows and, in part, will be obvious from the description, or may be learned by practice of the invention.

According to an aspect, an information storage medium is provided in which data is recorded in recording units. Each of the recording units comprises a body including user data and a first recognizer, and a head which is arranged in front of the body to protect the body and includes a second recognizer to protect the first recognizer. The second recognizer comprises more patterns than a number of maximum length patterns used to form the first recognizer so that the second recognizer is distinguished from the first recognizer.

Each of the recording units further comprises a tail which is arranged behind the body and includes a third recognizer.

According to an aspect, an information storage medium is provided in which data is recorded in recording units. Each of the recording units comprises a body and a head. The body includes user data, an error correction parity, and an error correction code (ECC) sync. The head is disposed in front of the body to protect the body. The head includes a head identifying pattern which is unique such that the head identifying pattern cannot be detected from any other data areas.

The head identifying pattern is disposed in the rear part of the head and comprises a head closing mark (HCM), which marks the closing of the head.

Each of the recording units further comprises a tail which is disposed behind the body and includes a tail opening mark (TOM), which marks the closing of the tail.

According to another aspect, an apparatus is provided for reproducing data recorded on a disk in recording units, each of the recording units comprising: a body including user data and a first recognizer; and a head which is disposed in front of the body to protect the body and includes a second recognizer to protect the first recognizer. The second recognizer comprises more patterns than a number of maximum length patterns used to form the first recognizer so that the second recognizer is distinguished from the first recognizer. The apparatus further comprises a pickup and a binary decoder. The pickup detects a radio frequency (RF) signal from the disk. The binary decoder receives the RF signal from the pickup. If the second recognizer is detected and the first recognizer is detected from a data area predetermined in the second recognizer, the binary decoder determines from the first recognizer that the body starts and obtains binary data from the RF signal.

If the second recognizer is detected but the first recognizer is not detected from a data area ranging from the second recognizer to a predetermined point, the binary decoder inserts the first recognizer into a location, which is a predetermined distance apart from the second recognizer, and determines from an inserted first interpolator that the body starts.

Each of the recording units further comprises a tail, which is disposed behind the body, and includes a third recognizer. If the second recognizer is not detected and the first recognizer is detected from the data area ranging from a judged location of the third recognizer to the predetermined point, the binary decoder determines from the first recognizer that the body starts.

Each of the recording units further comprises a tail, which is disposed behind the body, and includes the third recognizer. If the second recognizer is not detected and the first recognizer is not detected from the data area ranging from a judged location of the third recognizer to the predetermined point, the binary decoder re-searches for the second recognizer.

If the second recognizer is detected and the first recognizer is detected from the data area ranging from the second recognizer to the predetermined point, the binary decoder sets a window to protect the syncs included in the body based on the detected first recognizer.

If the second recognizer is detected and the first recognizer is not detected from the data area ranging from the second recognizer to the predetermined point, the binary decoder inserts the first recognizer into the location the predetermined distance apart from the second recognizer and sets a window to protect the syncs included in the body based on the inserted first recognizer.

Each of the recording units further comprises a tail which is disposed behind the body and includes the third recognizer, and if the second recognizer is not detected and the first recognizer is detected from the data area ranging from the judged location of the third recognizer to the predetermined point, the binary decoder sets a window to protect the syncs included in the body based on the detected first recognizer.

Each of the recording units further comprises a tail which is disposed behind the body and includes the third recognizer. If the second recognizer is not detected and the first recognizer is not detected from the data area ranging from the judged location of the third recognizer to the predetermined point, the binary decoder re-searches for the second recognizer.

According to another aspect, an apparatus for reproducing data recorded on a disk in recording units is provided, each of the recording units comprising: a body including user data, an error correction parity, and an ECC sync; and a head which is disposed in front of the body to protect the body. The head further includes a head identifying pattern which is unique such that the head identifying pattern cannot be detected from any other data areas. The apparatus comprises a pickup and a binary decoder. The pickup detects a radio frequency (RF) signal from the disk. The binary decoder receives the RF signal from the pickup and, if the head identifying pattern is detected and the ECC sync is detected from a data area ranging from the head identifying pattern to a predetermined point, determines from the ECC sync that the body starts and obtains binary data from the RF signal.

According to another aspect, a method of recording data on a recordable information storage medium is provided. In the method, data is recorded in recording units. Each of the recording units comprises a body, which includes user data and a first recognizer, and a head which is disposed in front of the body to protect the body and includes a second recognizer to protect the first recognizer. The second recognizer comprises more patterns than a number of maximum length patterns used to form the first recognizer so that the second recognizer is distinguished from the first recognizer.

According to another aspect a method of protecting the syncs included in data that has been recorded on a recordable disk in recording units is provided. Each of the recording units comprises: a body including user data, an error correction parity, and an ECC sync; and a head, which is disposed in front of the body, to protect the body, and includes a head identifying pattern which is unique such that the head identifying pattern cannot be detected from any other data areas. In the method, if the head identifying pattern is detected and the ECC sync is detected from a data area ranging from the head identifying pattern to a predetermined point, from the ECC sync the body is determined to start.

The head identifying pattern is disposed in the rear part of the head and comprises an HCM, and the HCM comprises more patterns than a number of maximum length patterns used to form the ECC sync so that the HCM is distinguished from the ECC sync.

If the HCM is detected but the ECC sync is not detected from a data area ranging from the second recognizer to a predetermined point, the ECC sync is inserted into a location which is a predetermined distance apart from the HCM, and from the inserted ECC sync the body is determined to start.

The recording unit further comprises a tail which is disposed behind the body and includes a TOM. If the HCM is not detected and the ECC sync is detected from a data area ranging from a judged location of the TOM to a predetermined point, from the ECC sync the body is determined to start.

The recording unit further comprises the tail, which is disposed behind the body and includes the TOM. If the HCM is not detected and the ECC sync is not detected from a data area ranging from a judged location of the TOM to a predetermined point, a search is again conducted for the HCM.

The recording unit further comprises the tail, which is disposed behind the body and includes the TOM. If the HCM is not detected and the ECC sync is not detected from a data area ranging from the judged location of the third recognizer to a predetermined point, the ECC sync is obtained using an ECC sync protection routine, and a search is again conducted for the HCM.

If the HCM is detected and the ECC sync is detected from a data area ranging from the HCM to a predetermined point, a window to protect the syncs included in the body is set based on the detected ECC sync.

If the HCM is detected and the ECC sync is not detected from the data area ranging from the HCM to the predetermined point, the ECC sync is inserted into a location, which is a predetermined distance apart from the HCM, and a window to protect the syncs included in the body is set based on the inserted ECC sync.

The recording unit further comprises the tail, which is disposed behind the body and includes the TOM. If the HCM is not detected and the ECC sync is detected from the data area ranging from the judged location of the TOM to the predetermined point, a window to protect the syncs included in the body is set based on the detected ECC sync.

The recording unit further comprises the tail which is disposed behind the body and includes the TOM. If the HCM is not detected and the ECC sync is not detected from the data area ranging from the judged location of the TOM to the predetermined point, a search is again conducted for the HCM.

The recording unit further comprises the tail which is disposed behind the body and includes the TOM. If the HCM is not detected and the ECC sync is not detected from the data area ranging from the judged location of the TOM to the predetermined point, the ECC sync is obtained using the ECC sync protection routine, and a search is again conducted for the HCM.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating an operation in which data is recorded on a conventional DVD-RW;

FIGS. 2 through 4 are diagrams illustrating three different cases in which new data is recorded according to a conventional data recording method based on data linking;

FIG. 5 is a block diagram of a reproducing apparatus according to a first embodiment of the present invention;

FIG. 6 shows a structure of data that is recorded on a disk using a data recording method according to the first embodiment of the present invention;

FIG. 7 shows a structure of data recorded on the disk using a data recording method according to a second embodiment of the present invention;

FIG. 8 is a flowchart illustrating how a first recognizer is detected and inserted into data based on a second recognizer;

FIG. 9 is a flowchart illustrating how a window to protect syncs within a body frame is produced based on the second recognizer;

FIG. 10 shows a structure of data recorded on the disk using a data recording method according to a third embodiment of the present invention;

FIG. 11 shows a structure of the head of FIG. 10 according to a fourth embodiment of the present invention;

FIG. 12 is a flowchart illustrating how an ECC sync is detected and inserted into data based on a head closing mark (HCM); and

FIG. 13 is a flowchart illustrating how a window to protect syncs within a body frame is produced based on the HCM.

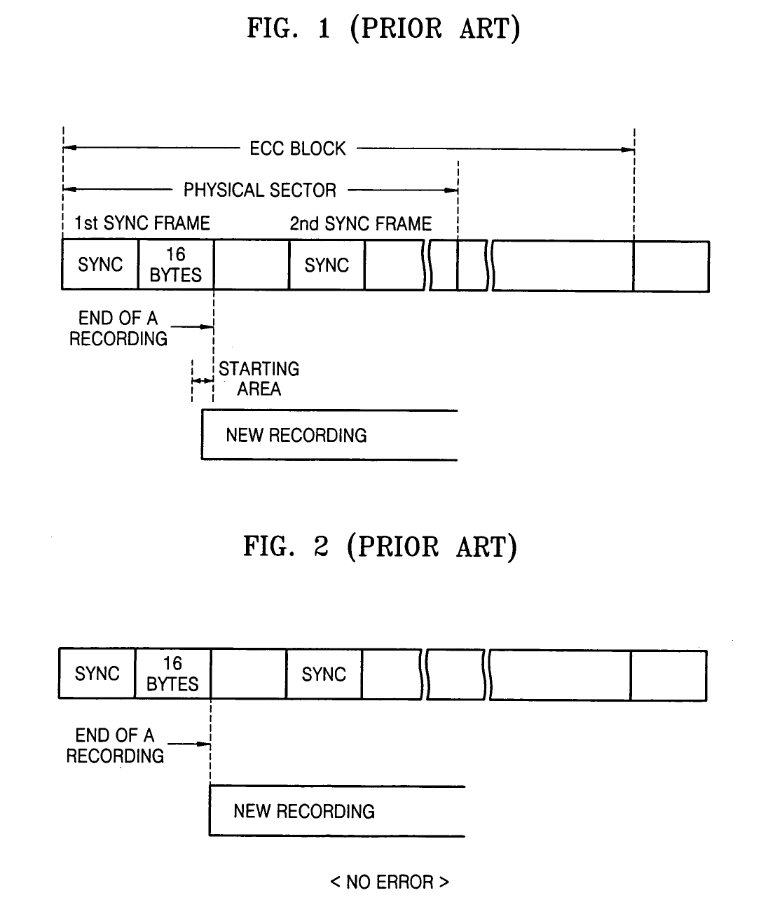

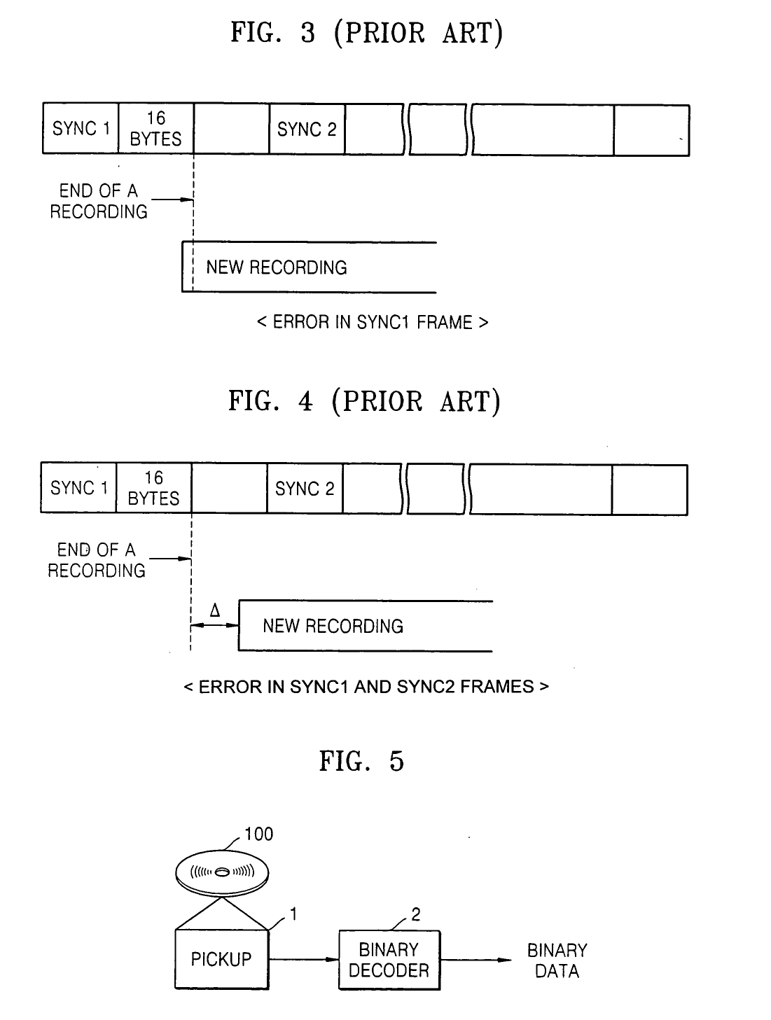

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 5 is a block diagram of a reproducing apparatus according to a first embodiment of the present invention which reproduces data that is recorded on a disk 100 having a data structure that enables recorded data to be properly reproduced. Referring to FIG. 5, the reproducing apparatus comprises a pickup 1 and a binary decoder 5. The pickup 1 projects a laser beam onto the disk 100, receives a laser beam reflected by the disk 100, and outputs a radio frequency (RF) signal corresponding to the received laser beam. The binary decoder 2 obtains binary data from the RF signal.

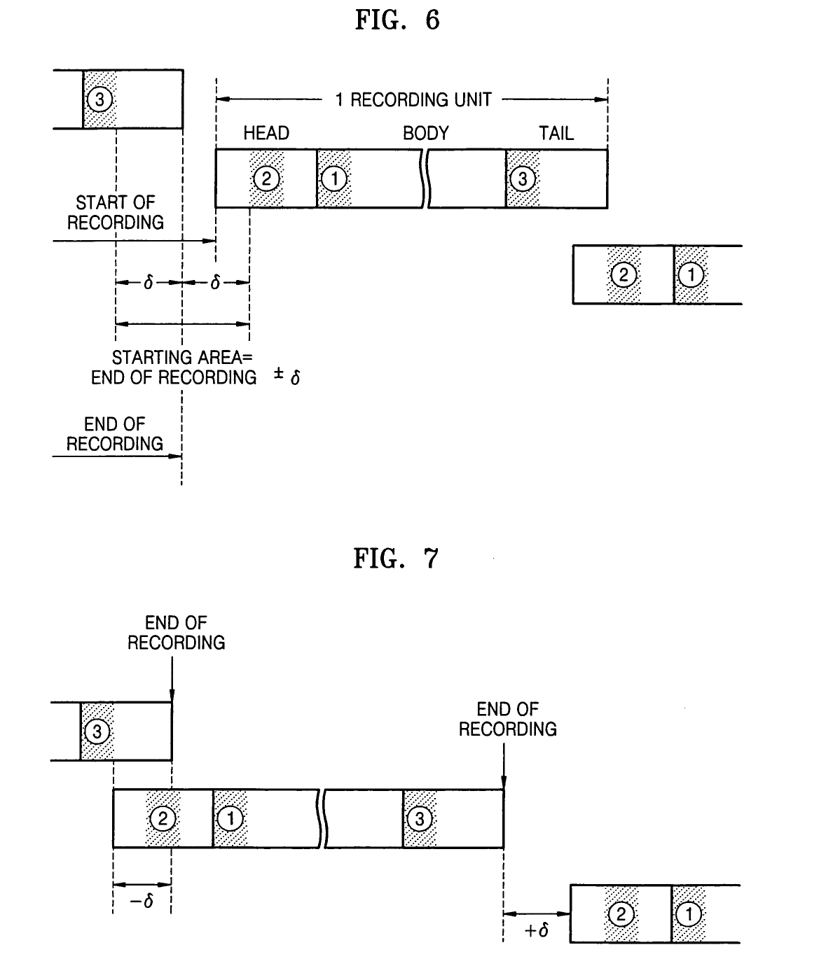

FIG. 6 shows a structure of data that is recorded on the disk 100 using a data recording method according to the first embodiment of the present invention. Referring to FIG. 6, data is recorded on a track (not shown) of the disk 100 in recording units. A recording unit denotes a minimum logical unit in which data is recorded. Further, data recording on the disk 100 starts at one recording unit and ends with the same or another recording unit. An error correction code (ECC) block is generally used as the recording unit.

The recording unit comprises a head, a body and a tail. The head is attached to the head (i.e., beginning) of the body to protect data contained in the body during data reproduction. The body contains user data. A first recognizer \mathring{1} corresponding to sync data is disposed in a head part of the body and indicates a start of the body. The body also includes an error correction parity.

The head and the tail are attached to the head and rear (i.e., ending) of the body, respectively, to protect the body when new recording occurs based on data linking. Particularly, the head protects the first recognizer \mathring{1}, and the tail protects the user data contained in the body.

Each of the head and of the tail includes a recognizer That is, the head and the tail include a second recognizer \mathring{2} and a third recognizer \mathring{3}, respectively. The second recognizer \mathring{2} protects the first recognizer \mathring{1} included in the body, and the third recognizer \mathring{3} indicates an end of the body. The second recognizer \mathring{2} is disposed after a predetermined time from a start of recording, that is, the second recognizer \mathring{2} is disposed at a location on the disk corresponding to after the predetermined time from the start of the head. In the first embodiment, the second recognizer \mathring{2} is disposed after a duration in which a phase locked loop (PLL) obtained from data being reproduced is sufficiently stabilized. The third recognizer \mathring{3} is disposed in a head part of the tail. Since a recognizer plays a role of conventional sync data, a pattern of the recognizer is different from a pattern in which binary data is recorded in a residual data area. Thus, the recognizer is distinguished from other binary data.

Compared with a conventional data structure, the data structure of FIG. 6 includes the second recognizer \mathring{2} disposed in the head to protect the first recognizer \mathring{1} included in the body. The second recognizer \mathring{2} is recorded with patterns different from patterns of other recognizers (recognizers of other areas, i.e., the head, the body, and the tail) are recorded. To be further distinguished from recognizers of the other areas, the second recognizer \mathring{2} comprises only pit (or mark) patterns that are at least 2T greater than or 2T smaller than the patterns for the other areas. Further, pits (or marks) are formed on a track of the disk 100, and T denotes a cycle of a channel clock. Accordingly, the second recognizer \mathring{2} is distinguishable from recognizers of the other areas even if an error of about ±1T is generated.

Alternatively, the recording unit may have a structure in which only the head is attached to the body of the recording unit or a structure in which only the tail is attached to the body of the recording unit. The detailed structures of the head, body, and tail have already been described above.

FIG. 7 shows a structure of data that is recorded on the disk 100 using a data recording method according to a second embodiment of the present invention. Referring to FIG. 7, data to be recorded is included in a body, a head and a tail are disposed in front of and behind the body, respectively, and the head includes the second recognizer \mathring{2}, which protects the first recognizer \mathring{1}, which indicates the start of the body. The second recognizer \mathring{2} is disposed on the disk 100 after a point of time when a data PLL is sufficiently stabilized during reproduction, from a moment when recording starts, that is, from a start location of the head. Consequently, although the data PLL at the location where linking-based recording is implemented is unstable, the second recognizer \mathring{2} may be stably detected after the data PLL is sufficiently stabilized.

An effect is that a margin where data linking occurs may be greatly extended from a maximum of several bytes in the conventional technique to a length (δ) of a tail excluding the third recognizer \mathring{3}. The margin in the data recording direction, that is, a positive (+) direction, does not need to be limited to δ. However, typically, a ±δ margin for data linking is secured from an end of recording.

A large margin as described above may be secured because of an existence of the second recognizer \mathring{2}. That is, because the second recognizer \mathring{2} is located in a place where recording starts (i.e., in the head), and a danger does not exist of the second recognizer \mathring{2} being damaged due to linking-based recording. Further, because the second recognizer \mathring{2} is located after the data PLL is stabilized, such that the second recognizer \mathring{2} is easily detectable. The detection of the second recognizer \mathring{2} enables a prediction of a time when the first recognizer \mathring{1} is to be generated. Thus, a conventional erroneous detection problem, such that the first recognizer \mathring{1} is detected from the outside of a protection window, is not generated. The second recognizer \mathring{2} is stably detectable by comprising patterns different from patterns of the other recognizers in the head, the body, and the tail which are recorded. To be further distinguished from the other recognizers \mathring{1} and \mathring{3} of the other areas the second recognizer \mathring{2} comprises only pit (or mark) patterns that are at least 2T greater than or 2T smaller than the patterns for the other recognizers \mathring{1} and \mathring{3} of the other areas. Thus, pits (or marks) are formed on the track of the disk 100, and T denotes the cycle of the channel clock. Accordingly, the second recognizer \mathring{2} is distinguishable from the other recognizers \mathring{1} and \mathring{3} of the other areas even if the error of about ±1T is generated.

Further, the second recognizer \mathring{2} comprises a greater number of patterns than a number of maximum length patterns that are used to form the first or third recognizer \mathring{1} or \mathring{3}. If a run length limited (RLL) (1, 10) modulation code is used, the first recognizer \mathring{1} generally comprises one or two maximum length patterns of no less than 12T In this case, the second recognizer \mathring{2} comprises more maximum length patterns of no less than 12T than the one or two maximum length patterns so that it is apparently distinguished from the first recognizer \mathring{1}.

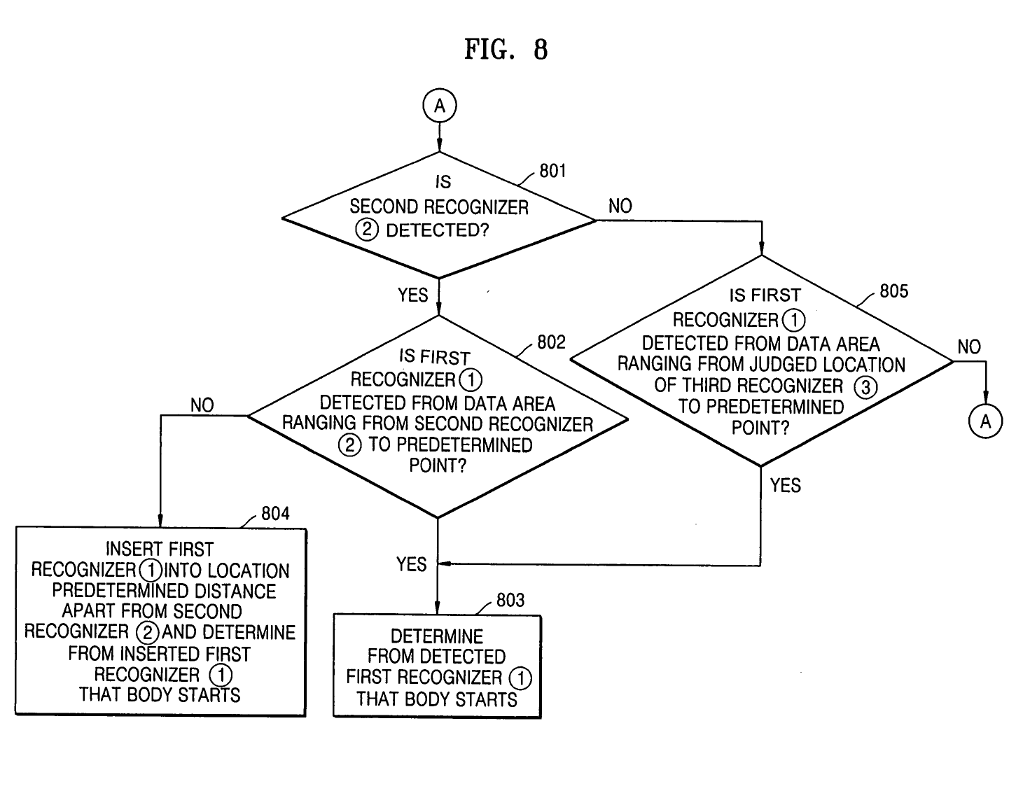

FIG. 8 is a flowchart illustrating how the first recognizer \mathring{1} is detected and inserted based on the second recognizer \mathring{2}. Referring to FIG. 8, if the second recognizer \mathring{2} is detected in operation 801 and the first recognizer \mathring{1} is detected from a data area ranging from the second recognizer \mathring{2} to a predetermined point in operation 802, from the detected first recognizer \mathring{1} a body is determined to start, in operation 803.

If the second recognizer \mathring{2} is detected in operation 801 but the first recognizer \mathring{1} is not detected from the data area ranging from the second recognizer \mathring{2} to the predetermined point in operation 802, the first recognizer \mathring{1} is inserted at a location, which is a predetermined distance apart from the second recognizer \mathring{2}, and from the inserted first recognizer \mathring{1} the body is determined to start, in operation 804.

If the second recognizer \mathring{2} is not detected in operation 801, and the first recognizer \mathring{1} is detected from a data area ranging from a location which is judged as the third recognizer \mathring{3} to a predetermined point in operation 805, from the detected first recognizer \mathring{1} a body is determined to start, in operation 803.

If the second recognizer \mathring{2} is not detected in operation 801, and the first recognizer \mathring{1} is not detected from the data area ranging from the location which is judged as the third recognizer \mathring{3} to the predetermined point in operation 805, operation 801 of searching for the second recognizer \mathring{2} is executed again.

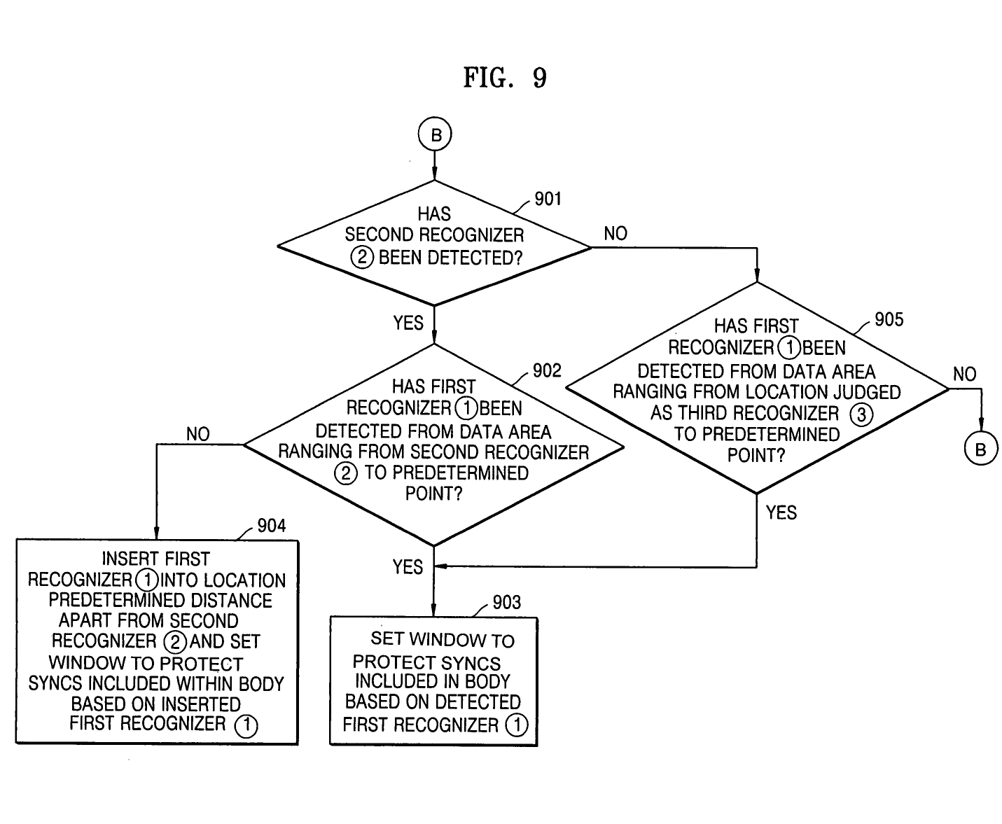

FIG. 9 is a flowchart illustrating how a window to protect the syncs included in a body is produced based on the second recognizer \mathring{2}. Referring to FIG. 9, if the second recognizer \mathring{2} is detected in operation 901 and the first recognizer \mathring{1} is detected from a data area ranging from the second recognizer \mathring{2} to a predetermined point in operation 902, the window to protect the syncs included in the body is set based on the detected first recognizer \mathring{1}, in operation 903. If the second recognizer \mathring{2} is detected in operation 901 but the first recognizer \mathring{1} is not detected from the data area ranging from the second recognizer \mathring{2} to a predetermined point in operation 902, the first recognizer \mathring{1} is inserted into a location, which is a predetermined distance apart from the second recognizer \mathring{2}, and the window to protect the syncs within the body is set based on the inserted first recognizer \mathring{1}, in operation 904.

If the second recognizer \mathring{2} is not detected in operation 901, and the first recognizer \mathring{1} is detected from a data area ranging from a location judged as the third recognizer \mathring{3} to a predetermined point in operation 905, the window to protect the syncs within the body is set based on the detected first recognizer \mathring{1}, in operation 903.

If the second recognizer \mathring{2} is not detected in operation 901, and the first recognizer \mathring{1} is not detected from the data area ranging from the location judged as the third recognizer \mathring{3} to the predetermined point in operation 905, operation 901 of searching for the second recognizer \mathring{2} is executed again. This sync protection & insertion method is disclosed in Korean Patent Publication No. 54370, entitled “Sync Detection Apparatus and Apparatus for Reproducing Optical Disk by Using the Sync Detection Apparatus”, filed on Dec. 26 1997 and published on Jul. 5 1997, assigned to the applicant of the present invention.

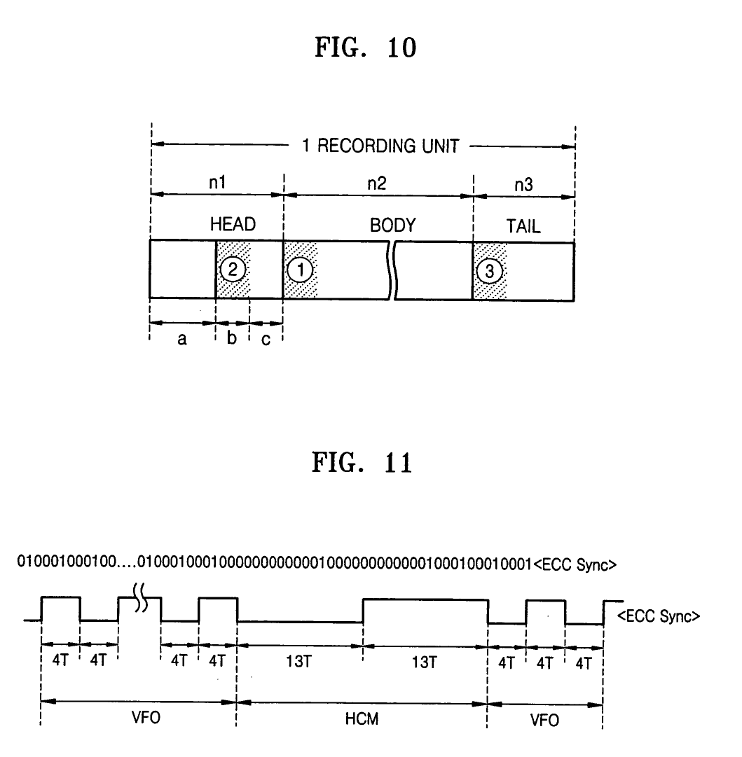

FIG. 10 shows a structure of data recorded on the disk 100 using a data recording method according to a third embodiment of the present invention. In FIG. 10, a head in a recording unit structure is illustrated in greater detail than other portions of the recording unit. The head of FIG. 10 may be applied to both the data structures of FIGS. 6 and 7.

Referring to FIG. 10, the first recognizer \mathring{1} denotes an error correction code (ECC) sync of an ECC block, the second recognizer \mathring{2} denotes a head closing mark (HCM) which indicates an end of the head, and the third recognizer \mathring{3} denotes a tail opening mark (TOM) which indicates a start of a tail.

In FIG. 10, n1 denotes a length (a+b+c) of the head. The head may include a pattern which protects a body and is for a PLL. The pattern for the PLL may be a repetition of marks (or pits) each having an identical length. Data within a body corresponding to one ECC block is typically protected by a protection of the ECC sync \mathring{1}, which indicates a start of the body. For example, a mark that enables recognition of the head may be disposed in the head to protect the ECC sync \mathring{1}. The mark may be a unique pattern that cannot be found in other areas, and may be located at the end of the head. A repeated pattern for the PLL may be interposed between the mark and the ECC sync \mathring{1}.

For example, a recording/reproducing apparatus, which has a minimum run length d of 1 and a maximum run length k of 10, uses a modulation code which modulates 8-bit data into a 12-bit codeword. In the above-described recording/reproducing apparatus, a minimum mark (or pit) is 2T and a maximum mark (or pit) is 11T Further, 1T denotes a cycle of a channel clock for data reproduction. If the above-described recording/reproducing apparatus uses a 13T mark (or pit) for the ECC sync, the length (n1) of the head is set to 71 bytes, a length (b) of the HCM is set to 2 bytes, and a length (c) between the HCM and the ECC sync \mathring{1} is set to 1 byte. Thus, a length (a) between the head and the HCM is 68 bytes. If a codeword ‘010001000100’ is repeated during the 68-byte length (a) and used as a PLL pattern, that is, a variable frequency oscillator (VFO), ‘000000000010000000000001’ is used for an HCM pattern with a 2-byte length, and ‘000100010001’ corresponding to a 1-byte length is used for a pattern behind the HCM, a codeword ‘010001000100’before the HCM and ‘000000000010000000000001’ corresponding to the HCM meet each other to generate two 3T marks (or pits). The two 3T marks (or pits) correspond to a unique pattern that does not appear in other data areas. By detecting this pattern, the ECC sync may be inserted when the detection of the ECC sync fails. The pattern ‘000100010001’ behind the HCM not only is a PLL pattern (a VFO) but also is a pattern which determines a sync protection window to discover the HCM and to detect the ECC sync. A head structure produced as described above is shown in FIG. 11.

An operation of protecting the ECC sync included in the body and other syncs by using the HCM included in the head as shown in FIG. 11 will now be described.

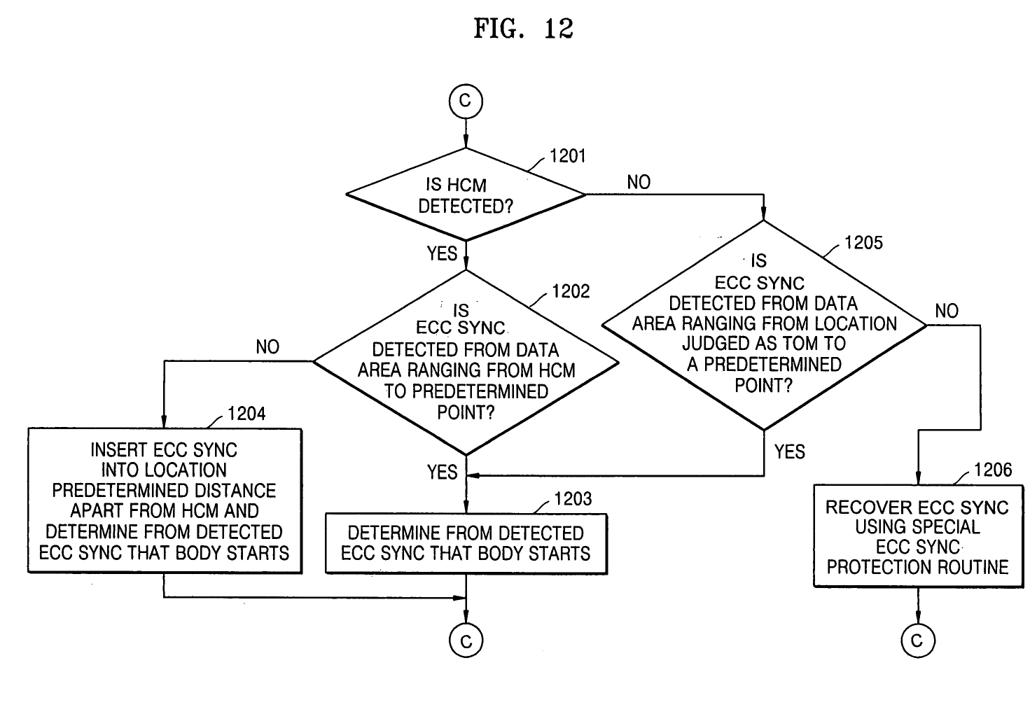

FIG. 12 is a flowchart illustrating how the ECC sync is detected and inserted into a data structure based on the HCM. Referring to FIG. 12, if the HCM is detected in operation 1201 and the ECC sync is detected from a data area ranging from the HCM to a predetermined point in operation 1202, from the detected ECC sync a body is determined to start, in operation 1203. If the HCM is detected in operation 1201 but no ECC syncs are detected from the data area ranging from the HCM to the predetermined point in operation 1202, the ECC sync is inserted into a location, which is predetermined distance apart from the HCM, and from the detected ECC sync the body is determined to start, in operation 1204.

If no HCM is detected in operation 1201, and the ECC sync is detected from a data ranging from a location judged as a tail opening mark (TOM) to a predetermined point in operation 1205, from the detected ECC sync the body is determined to start, in operation 1203. If no HCM is detected in operation 1201, and no ECC sync is detected from the data ranging from the location judged as the TOM to the predetermined point in operation 1205, an ECC sync is recovered using a special ECC sync protection routine in operation 1206. Thereafter, a next HCM is searched for in operation 1201. The special ECC sync protection routine will not be described here. The methods of FIGS. 8 and 9 may also include an operation of performing an ECC sync protection routine, if the first recognizer \mathring{1} is not detected from the data ranging from the location judged as the third recognizer \mathring{3} to the predetermined point.

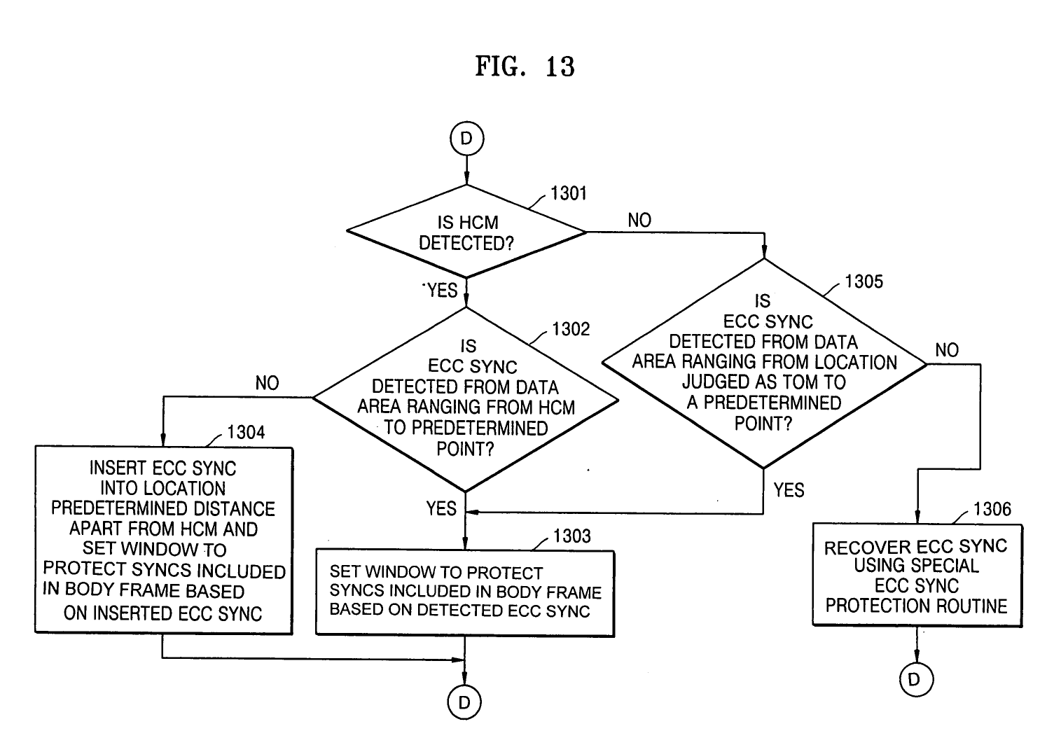

FIG. 13 is a flowchart illustrating how a window to protect syncs within a body frame is produced based on the HCM. Referring to FIG. 13, if the HCM is detected in operation 1301 and the ECC sync is detected from a data area ranging from the HCM to a predetermined point in operation 1302, a window to protect the syncs included in the body frame is set based on the detected ECC sync, in operation 1303. If the HCM is detected in operation 1301 but no ECC sync is detected from the data area ranging from the HCM in operation 1302, the ECC sync is inserted into a location, which is a predetermined distance apart from the HCM, and the window to protect the syncs included in the body frame is set based on the inserted ECC sync, in operation 1304. If no HCM is detected in operation 1301, and the ECC sync is detected from a data area ranging from a location judged as the TOM to a predetermined point in operation 1305, the window to protect the syncs included in the body frame is determined from the detected ECC sync, in operation 1303. If no HCM is detected in operation 1301, and no ECC sync is detected from the data area ranging from the location judged as the TOM to the predetermined point in operation 1305, the ECC sync is recovered using a special ECC sync protection routine in operation 1306. Thereafter, a next HCM is searched for in operation 1301.

According to the present invention, a margin where data linking occurs is greatly extendable from a maximum of several bytes in the conventional technique to a length (δ) of a tail excluding a third recognizer. Thus, even if data is recorded on a recordable disk at any time, the data is properly reproducible. Further, a data structure according to the present invention is applicable to an optical disk recording/reproducing apparatus and a magnetic disk recording/reproducing apparatus to stably restore data when the recording/reproducing apparatus reads out stored data or receives transmitted data.

Further, user data is stably reproducible by protecting all of the syncs included in the data structure.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information storage medium in which data is recorded in recording units, each of the recording units comprising:
a body including user data and a first recognizer; and
a head which is arranged in front of the body to protect the body and includes a second recognizer to protect the first recognizer,
wherein the second recognizer comprises more patterns than a number of maximum length patterns used to form the first recognizer so that the second recognizer is distinguished from the first recognizer.

2. The information storage medium of claim 1, wherein the recording unit further comprises a tail which is arranged behind the body and includes a third recognizer.

3. The information storage medium of claim 1, wherein when a run length limited (1, 10) modulation code is used, the first recognizer uses a 12T pattern, and the second recognizer uses two 12T patterns.

4. The information storage medium of claim 1, wherein when a run length limited (1, 10) modulation code which modulates 8-bit data into a 12-bit codeword is used, the first recognizer uses a 13T pattern, and the second recognizer uses two 13T patterns.

5. The information storage medium of claim 1, wherein the second recognizer is located in a rear part of the head.

6. The information storage medium of claim 1, wherein a mark or a pit with a specific length is repeatedly recorded for a length of A number of bytes in the head for a data phase locked loop.

7. The information storage medium of claim 6, wherein a pattern ‘010001000100’ is used so that the mark or pit with the specific length is repeated.

8. The information storage medium of claim 6, wherein the length of the A byte is 68.

9. The information storage medium of claim 6, wherein a pattern not detectable from any other patterns is used for a length of B number of bytes as a recognition pattern for the second recognizer, which identifies the head.

10. The information storage medium of claim 6, wherein a pattern not detectable from any other patterns is used for a length of B number of bytes as a recognition pattern for the second recognizer, which identifies the head, and the recognition pattern is connected to a pattern in front of the recognition pattern.

11. The information storage medium of claim 9, wherein a pattern ‘000000000010000000000001’ is used to form the second recognizer.

12. The information storage medium of claim 10, wherein a pattern ‘000000000010000000000001’ is used to form the second recognizer.

13. The information storage medium of claim 9, wherein the length of the B bytes is 2.

14. The information storage medium of claim 10, wherein the length of the B bytes is 2.

15. The information storage medium of claim 9, wherein a phase locked loop pattern subsequent to the pattern for the second recognizer is a repetition of a mark or pit with a specific length during a residual C number of bytes of the head.

16. The information storage medium of claim 10, wherein a phase locked loop pattern subsequent to the pattern for the second recognizer is a repetition of a mark or a pit with a specific length during a residual C number of bytes of the head.

17. The information storage medium of claim 15, wherein a pattern ‘000100010001’ is used for the repetition of the mark or the pit with the specific length.

18. The information storage medium of claim 15, wherein the length of the C bytes is 1.

19. An information storage medium in which data is recorded in recording units, each of the recording units comprising:
a body including user data, an error correction parity, and an error correction code (ECC) sync; and
a head which is disposed in front of the body to protect the body,
wherein the head includes a head identifying pattern which is unique such that the head identifying pattern cannot be detected from any other patterns.

20. The information storage medium of claim 19, wherein the head identifying pattern is disposed in a rear part of the head and comprises a head closing mark, which marks a closing of the head.

21. The information storage medium of claim 20, wherein the head closing mark comprises more patterns than a number of maximum length patterns used to form the ECC sync so that the head closing mark is distinguished from the ECC sync.

22. The information storage medium of claim 20, wherein each of the recording units further comprises a tail which is disposed behind the body and includes a tail opening mark, which marks a closing of the tail.

23. The information storage medium of claim 19, wherein a mark or a pit with a specific length is repeatedly recorded for a length of A number of bytes in the head for a data phase locked loop.

24. The information storage medium of claim 23, wherein a pattern ‘010001000100’ is used so that the mark or pit with the specific length is repeated.

25. The information storage medium of claim 23, wherein the length of the A bytes is 68.

26. The information storage medium of claim 23, wherein a pattern not detectable from any other patterns is used for a length of B number of bytes as the head identifying pattern.

27. The information storage medium of claim 23, wherein a pattern not detectable from any other patterns is used for a length of B number of bytes as a recognition pattern for the second recognizer, which identifies the head, and the recognition pattern is connected to a pattern in front of the recognition pattern.

28. The information storage medium of claim 26, wherein a pattern ‘000000000010 000000000001’ is used to form the head identifying pattern.

29. The information storage medium of claim 27, wherein a pattern ‘000000000010 000000000001’ is used to form the head identifying pattern.

30. The information storage medium of claim 26, wherein the length of the B bytes is 2.

31. The information storage medium of claim 27, wherein the length of the B bytes is 2.

32. The information storage medium of claim 26, wherein the mark or the pit with the specific length is repeated for a length of C number of bytes so that the head identifying pattern and a pattern connected to the head identifying pattern provide a data phase locked loop.

33. The information storage medium of claim 27, wherein the mark or the pit with a specific length is repeated for a length of C number of bytes so that the head identifying pattern and a pattern connected to the head identifying pattern provide a data phase locked loop.

34. The information storage medium of claim 32, wherein a pattern ‘000100010001’ is used for a repetition of the mark or the pit with the specific length.

35. The information storage medium of claim 32, wherein the length of the C bytes is 1.

36. An apparatus for reproducing data recorded on a disk in recording units, each of the recording units comprising: a body including user data and a first recognizer; and a head which is disposed in front of the body to protect the body and includes a second recognizer to protect the first recognizer, wherein the second recognizer comprises more patterns than a number of maximum length patterns used to form the first recognizer so that the second recognizer is distinguished from the first recognizer, the apparatus comprising:
a pickup which detects a radio frequency signal from the disk; and
a binary decoder which receives the radio frequency signal from the pickup and, if the second recognizer is detected and the first recognizer is detected from a data area predetermined in the second recognizer, determines from the first recognizer that the body starts and obtains binary data from the radio frequency signal.

37. The apparatus of claim 36, wherein if the second recognizer is detected but the first recognizer is not detected from a data area ranging from the second recognizer to a predetermined point, the binary decoder inserts the first recognizer into a location, which is a predetermined distance apart from the second recognizer, and determines from the inserted first recognizer that the body starts.

38. The apparatus of claim 36, wherein the recording unit further comprises a tail which is disposed behind the body and includes a third recognizer, and if the second recognizer is not detected and the first recognizer is detected from a data area ranging from a judged location of the third recognizer to a predetermined point, the binary decoder determines from the first recognizer that the body starts.

39. The apparatus of claim 36, wherein the recording unit further comprises a tail which is disposed behind the body and includes a third recognizer, and if the second recognizer is not detected and the first recognizer is not detected from a data area ranging from a judged location of the third recognizer to a predetermined point, the binary decoder re-searches for the second recognizer.

40. The apparatus of claim 36, wherein the recording unit further comprises a tail which is disposed behind the body and includes a third recognizer, and if the second recognizer is not detected and the first recognizer is not detected from a data area ranging from a judged location of the third recognizer to a predetermined point, the binary decoder obtains a first recognizer using a first recognizer protection routine and re-searches for the second recognizer.

41. The apparatus of claim 36, wherein if the second recognizer is detected and the first recognizer is detected from a data area ranging from the second recognizer to a predetermined point, the binary decoder sets a window to protect syncs included in the body based on the detected first recognizer.

42. The apparatus of claim 36, wherein if the second recognizer is detected and the first recognizer is not detected from a data area ranging from the second recognizer to a predetermined point, the binary decoder inserts the first recognizer into a location, which is a predetermined distance apart from the second recognizer, and sets a window for protecting the syncs included in the body based on the inserted first recognizer.

43. The apparatus of claim 36, wherein the recording unit further comprises a tail which is disposed behind the body and includes a third recognizer, and if the second recognizer is not detected and the first recognizer is detected from a data area ranging from a judged location of the third recognizer to a predetermined point, the binary decoder sets a window to protect syncs included in the body based on the detected first recognizer.

44. The apparatus of claim 36, wherein the recording unit further comprises a tail which is disposed behind the body and includes a third recognizer, and if the second recognizer is not detected and the first recognizer is not detected from a data area ranging from a judged location of the third recognizer to a predetermined point, the binary decoder re-searches for the second recognizer.

45. The apparatus of claim 36, wherein the recording unit further comprises a tail which is disposed behind the body and includes a third recognizer, and if the second recognizer is not detected and the first recognizer is not detected from a data area ranging from a judged location of the third recognizer to a predetermined point, the binary decoder obtains a first recognizer using a first recognizer protection routine and re-searches for the second recognizer.

46. An apparatus for reproducing data recorded on a disk in recording units, each of the recording units comprising: a body including user data, an error correction parity, and an ECC sync; and a head which is disposed in front of the body to protect the body, the head further including a head identifying pattern disposed in a data area, the head identifying pattern being unique such that the head identifying pattern cannot be detected from any other data areas, the apparatus comprising:
a pickup which detects a radio frequency signal from the disk; and
a binary decoder which receives the radio frequency signal from the pickup and, if the head identifying pattern is detected and the ECC sync is detected from a data area ranging from the head identifying pattern to a predetermined point, the binary decoder determines from the ECC sync that the body starts and obtains binary data from the radio frequency signal.

47. The apparatus of claim 46, wherein the head identifying pattern is disposed in a second half of the head and comprises a head closing mark, which marks a closing of the head, and the head closing mark comprises more patterns than a number of maximum length patterns used to form the ECC sync so that the head closing mark is distinguished from the ECC sync.

48. The apparatus of claim 46, wherein if the head closing mark is detected but the ECC sync is not detected from a data area ranging from the second recognizer to a predetermined point, the binary decoder inserts the ECC sync into a location, which is a predetermined distance apart from the head closing mark and determines from the inserted ECC sync that the body starts.

49. The apparatus of claim 47, wherein each of the recording units further comprises a tail which is disposed behind the body and includes a tail opening mark, which marks the opening of the tail, and if the head closing mark is not detected and the ECC sync is detected from a data area ranging from a judged location of the tail opening mark to a predetermined point, the binary decoder determines from the ECC sync that the body starts.

50. The apparatus of claim 47, wherein each of the recording units further comprises a tail which is disposed behind the body and includes a tail opening mark, which informs the opening of the tail, and if the head closing mark is not detected and the ECC sync is not detected from a data area ranging from a judged location of the tail opening mark to a predetermined point, the binary decoder re-searches for the head closing mark.

51. The apparatus of claim 47, wherein each of the recording units further comprises a tail which is disposed behind the body and includes a tail opening mark, which informs the opening of the tail, and if the head closing mark is not detected and the ECC sync is not detected from a data area ranging from a judged location of the third recognizer to a predetermined point, the binary decoder obtains an ECC sync using an ECC sync protection routine and re-searches for the head closing mark.

52. The apparatus of claim 47, wherein if the head closing mark is detected and the ECC sync is detected from a data area ranging from the head closing mark to a predetermined point, the binary decoder sets a window to protect the syncs included in the body based on the detected ECC sync.

53. The apparatus of claim 47, wherein if the head closing mark is detected and the ECC sync is not detected from a data area ranging from the head closing mark to a predetermined point, the binary decoder inserts the ECC sync into a location, which is a predetermined distance apart from the head closing mark and sets a window to protect the syncs included in the body based on the inserted ECC sync.

54. The apparatus of claim 47, wherein each of the recording units further comprises a tail which is disposed behind the body and includes a tail opening mark, which marks the opening of the tail, and if the head closing mark is not detected and the ECC sync is detected from a data area ranging from a judged location of the tail opening mark to a predetermined point, the binary decoder sets a window to protect the syncs included in the body based on the detected ECC sync.

55. The apparatus of claim 47, wherein each of the recording units further comprises a tail which is disposed behind the body and includes a tail opening mark, which marks the opening of the tail, and if the head closing mark is not detected and the ECC sync is not detected from a data area ranging from a judged location of the tail opening mark to a predetermined point, the binary decoder re-searches for the head closing mark.

56. The apparatus of claim 47, wherein each of the recording units further comprises a tail which is disposed behind the body and includes a tail opening mark, which marks the opening of the tail, and if the head closing mark is not detected and the ECC sync is not detected from a data area ranging from a judged location of the tail opening mark to a predetermined point, the binary decoder obtains the ECC sync using an ECC sync protection routine and re-searches for the head closing mark.

57. A method of recording data on a recordable information storage medium, the method comprising:
recording data in recording units,
wherein each of the recording units comprises: a body including user data and a first recognizer; and a head which is disposed in front of the body to protect the body and includes a second recognizer to protect the first recognizer, wherein the second recognizer comprises more patterns than a number of maximum length patterns used to form the first recognizer so that the second recognizer is distinguishable from the first recognizer.

58. The method of claim 57, wherein each of the recording units further comprises a tail which is disposed behind the body and includes a third recognizer.

59. The method of claim 57, wherein when a run length limited (1, 10) modulation code is used, the first recognizer uses a 12T pattern, and the second recognizer uses two 12T patterns.

60. The method of claim 57, wherein when a run length limited (1, 10) modulation code which modulates 8-bit data into a 12-bit codeword is used, the first recognizer uses a 13T pattern, and the second recognizer uses two 13T patterns.

61. The method of claim 57, wherein the second recognizer is located in a rear part of the head.

62. The method of claim 57, wherein a mark or a pit with a specific length is repeatedly recorded for a length of A number of bytes in the head for a data phase locked loop.

63. The method of claim 62, wherein a pattern ‘010001000100’ is used so that the mark or the pit with the specific length is repeated.

64. The method of claim 62, wherein the length of the A bytes is 68.

65. The method of claim 62, wherein a pattern not detectable from any other patterns is used for a length of B number of bytes as a recognition pattern for the second recognizer, which identifies the head.

66. The method of claim 62, wherein a pattern not detectable from any other patterns is used for a length of B number of bytes as a recognition pattern for the second recognizer, which identifies the head, and the recognition pattern is connected to a pattern in front of the recognition pattern.

67. The method of claim 65, wherein a pattern ‘000000000010000000000001’ is used to form the second recognizer.

68. The method of claim 66, wherein a pattern ‘000000000010000000000001’ is used to form the second recognizer.

69. The method of claim 65, wherein the length of the B bytes is 2.

70. The method of claim 66, wherein the length of the B bytes is 2.

71. The method of claim 65, wherein a phase locked loop pattern subsequent to the pattern for the second recognizer is a repetition of a mark or pit with a specific length during a residual C number of bytes of the head.

72. The method of claim 66, wherein a phase locked loop pattern subsequent to the pattern for the second recognizer is a repetition of a mark or pit with a specific length during a residual C number of bytes of the head.

73. The method of claim 71, wherein a pattern ‘000100010001’ is used for a repetition of the mark or the pit with the specific length.

74. The method of claim 71, wherein the length of the C bytes is 1.

75. The method of claim 57, wherein the user data is recorded in units of ECC blocks, the first recognizer is an ECC sync, the second recognizer is a head closing mark, which marks an end of the head, and the third recognizer is a tail opening mark, which marks a start of the tail.

76. A method of protecting syncs included in data that is recorded on a recordable disk in recording units, each of the recording units comprising: a body including user data, an error correction parity, and an ECC sync; and a head which is disposed in front of the body to protect the body, wherein the head includes a head identifying pattern which is unique such that the head identifying pattern cannot be detected from any other patterns, the method comprising:
if the head identifying pattern is detected and the ECC sync is detected from a data area ranging from the head identifying pattern to a predetermined point, determining from the ECC sync that the body starts.

77. The method of claim 76, wherein the head identifying pattern is disposed in a rear part of the head and comprises a head closing mark, which marks an end of the head, and the head closing mark comprises more patterns than a number of maximum length patterns used to form the ECC sync so that the head closing mark is distinguishable from the ECC sync.

78. The method of claim 77, further comprising, if the head closing mark is detected but the ECC sync is not detected from a data area ranging from the second recognizer to a predetermined point, inserting the ECC sync into a location, which is a predetermined distance apart from the head closing mark and determining from the inserted ECC sync that the body starts.

79. The method of claim 77, wherein each of the recording units further comprises a tail which is disposed behind the body and includes a tail opening mark, which marks a start of the tail, and the method further comprising, if the head closing mark is not detected and the ECC sync is detected from a data area ranging from a judged location of the tail opening mark to a predetermined point, determining from the ECC sync that the body starts.

80. The method of claim 77, wherein each of the recording units further comprises a tail which is disposed behind the body and includes a tail opening mark, which marks a start of the tail, and the method further comprising, if the head closing mark is not detected and the ECC sync is not detected from a data area ranging from a judged location of the tail opening mark to a predetermined point, re-searching for the head closing mark.

81. The method of claim 77, wherein each of the recording units further comprises a tail which is disposed behind the body and includes a tail opening mark, which marks a start of the tail, and the method further comprising, if the head closing mark is not detected and the ECC sync is not detected from a data area ranging from a judged location of the third recognizer to a predetermined point, obtaining an ECC sync using the ECC sync protection routine and re-searching for the head closing mark.

82. The method of claim 77, further comprising, if the head closing mark is detected and the ECC sync is detected from a data area ranging from the head closing mark to a predetermined point, setting a window to protect the syncs included in the body based on the detected ECC sync.

83. The method of claim 77, further comprising, if the head closing mark is detected and the ECC sync is not detected from a data area ranging from the head closing mark to a predetermined point, inserting the ECC sync into a location, which is a predetermined distance apart from the head closing mark and setting a window to protect the syncs included in the body based on the inserted ECC sync.

84. The method of claim 77, wherein each of the recording units further comprises a tail which is disposed behind the body and includes a tail opening mark, which marks a start of the tail, and the method further comprising, if the head closing mark is not detected and the ECC sync is detected from a data area ranging from a judged location of the tail opening mark to a predetermined point, setting a window to protect the syncs included in the body based on the detected ECC sync.

85. The method of claim 77, wherein each of the recording units further comprises a tail which is disposed behind the body and includes a tail opening mark, which marks a start of the tail, and the method further comprising, if the head closing mark is not detected and the ECC sync is not detected from a data area ranging from a judged location of the tail opening mark to a predetermined point, re-searching for the head closing mark.

86. The method of claim 77, wherein each of the recording units further comprises a tail which is disposed behind the body and includes a tail opening mark, which marks a start of the tail, and the method further comprising, if the head closing mark is not detected and the ECC sync is not detected from a data area ranging from a judged location of the tail opening mark to a predetermined point, obtaining the ECC sync using an ECC sync protection routine and re-searching for the head closing mark.

87. An information storage medium in which data is recorded in recording units, each of the recording units comprising:
a body including user data and a first recognizer; and
a head arranged preceding the body to safeguard the body, and including a second recognizer to safeguard the first recognizer, the second recognizer having a distinctive pattern so that the second recognizer is distinguishable from the first recognizer.

88. An apparatus for reproducing data recorded on a disk in recording units, each of the recording units comprising a body including user data and a first recognizer, and a head arranged preceding the body to safeguard the body, and including a second recognizer to safeguard the first recognizer, the second recognizer having a distinctive pattern so that the second recognizer is distinguishable from the first recognizer, the apparatus comprising:
a pickup to detect a recorded signal from the disk; and
a binary decoder to receive the detected signal from the pickup and, if the second recognizer is detected and the first recognizer is detected from a data area predetermined in the second recognizer, to determine from the first recognizer that the body starts and to obtain binary data from the detected signal.

89. A method of recording data on a recordable information storage medium, the method comprising:
recording data in recording units such that each of the recording units includes a body including user data and a first recognizer, and a head arranged preceding the body to safeguard the body, and including a second recognizer to safeguard the first recognizer, the second recognizer having a distinctive pattern so that the second recognizer is distinguishable from the first recognizer.

90. An information storage medium in which data is recorded in recording units, each of the recording units comprising:
a body including user data and a first recognizer; and
a head arranged preceding the body to safeguard the body, and including a second recognizer to safeguard the first recognizer by extending a margin in which data is linked between the head and the body of each respective recording unit.

91. An apparatus for reproducing data recorded on a disk in recording units, each of the recording units comprising a body including user data and a first recognizer, and a head arranged preceding the body to safeguard the body, and including a second recognizer to safeguard the first recognizer by extending a margin in which data is linked between the head and the body of each respective recording unit, a pickup to detect recorded signals from the disk, the apparatus comprising:
a decoder to receive the detected signal from the pickup and, if the first recognizer is detected according to information in a detected second recognizer, to link the head with the body of a respective one of the recoding units and to obtain data from the detected signal.

92. A method of protecting the syncs included in data that is recorded on a recordable disk in recording units, each of the recording units including a body including user data and a first recognizer, and a head arranged preceding the body to safeguard the body, and including a second recognizer to safeguard the first recognizer by extending a margin in which data is linked between the head and the body of each respective recording unit, and a pickup to detect signals from the recordable disk, the method comprising:
if the error correction code sync is detected according to information detected from a data area ranging from the head identifying pattern to a predetermined point, linking the head with the body of a respective one of the recoding units and obtaining data from the detected signal.
